(19) United States
(12) Patent Application Publication
(10) Pub. No.: US 2026/0050732 A1
(43) Pub. Date: Feb. 19, 2026

(54) GENERATING TARGETED LAYOUTS FROM SOURCE DOCUMENTS UTILIZING LARGE LANGUAGE MODELS WITH SEMANTIC HIERARCHICAL TRANSFORMATIONS

(71) Applicant: Adobe Inc., San Jose, CA (US)

(72) Inventors: Shwetha Somasundaram, Chennai (IN); Vaibhavi Nitin Lokegaonkar, Pune (IN); Khush Chetankumar Jain, Surat City (IN); Hemank Bajaj, Zirakpur (IN); Inderjeet Jayakumar Nair, Indore (IN); Anandhavelu N, Kangayam (IN)

(21) Appl. No.: 18/809,147

(22) Filed: Aug. 19, 2024

(51) Int. Cl. G06F 40/166; G06F 40/137; G06F 40/295

(52) U.S. Cl. CPC G06F 40/166; G06F 40/137; G06F 40/295

(57) ABSTRACT

The present disclosure is directed toward systems, methods, and non-transitory computer readable media that transform textual content from a source document into a target document. In particular, the disclosed systems utilize a text classification model based on textual elements and corresponding text classes from the target document to map the textual content into hierarchical sections within a document hierarchy. Additionally, the disclosed systems utilize a natural language intent classification model to generate named entity classifications for the textual elements of the target document. The disclosed systems utilize source text of the source document, the named entity classifications, the text classes, and the document hierarchy to generate a text transformation prompt for a language machine learning model. The disclosed systems utilize the language machine learning model to map text from the source document to the target document.

### BACKGROUND

Advancements in computing devices and computing systems have enabled the creation of visually rich documents in a variety of formats and styles. For example, diverse computing applications have been developed to generate visually rich documents by arranging textual content within a document by placing the content in specified locations. To facilitate this functionality, some existing computing applications integrate predefined textual content from labeled fields to provide a visually rich presentation of the textual content. However, due to the restricted nature of the textual mapping process, many such computing applications exhibit deficiencies regarding flexibility, accuracy, and operational efficiency, especially when generating context-specific textual content using varied templates and diverse source documents.

### SUMMARY

One or more embodiments provide benefits and/or solve one or more of the foregoing or other problems in the art with systems, methods, and non-transitory computer readable storage media that generate targeted layouts from source documents utilizing language machine learning models with semantic hierarchical transformations. In particular, in one or more implementations, the disclosed systems utilize a text classification model based on textual elements and corresponding text classes from the target document to map the textual content into hierarchical sections within a document hierarchy. Additionally, in some embodiments, the disclosed systems utilize a natural language intent classification model to generate named entity classifications for the textual elements of the target document. For example, the disclosed systems utilize source text of the source document, the named entity classifications, the text classes, and the document hierarchy to generate a text transformation prompt for a language machine learning model (e.g., a large language model). In one or more implementations, the disclosed systems utilize the language machine learning model to map text from the source document to the target document. In this way, in one or more embodiments, the disclosed systems utilize a language machine learning model to automatically generate a transformed document by extracting key information from a source PDF document, mapping the extracted key information to placeholders in a target document, and adjusting the content to meet the design constraints of the target document.

### BRIEF DESCRIPTION OF THE DRAWINGS

This disclosure will describe one or more example embodiments of the systems and methods with additional specificity and detail by referencing the accompanying figures. The following paragraphs briefly describe those figures, in which:

FIG. 1 illustrates a schematic diagram of an example environment of a document transformation system in accordance with one or more embodiments;

FIG. 2 illustrates an example overview of mapping a source document to a target document utilizing a language machine learning model in accordance with one or more embodiments;

FIG. 3 illustrates an example of generating a document hierarchy for a target document in accordance with one or more embodiments;

FIG. 4 illustrates an example of utilizing a text transformation prompt to generate a transformed document in accordance with one or more embodiments;

FIG. 5 illustrates an example of fine-tuning a text transformation prompt in accordance with one or more embodiments;

FIG. 6 illustrates an example of iteratively mapping textual content to generate the transformed document in accordance with one or more embodiments;

FIGS. 7A-7C illustrate an example of a document transformation system utilizing a graphical user interface to generate a transformed document from a PDF in accordance with one or more embodiments;

FIGS. 8A-8C illustrate an example of a document transformation system utilizing a graphical user interface to generate a transformed document from a long-form document in accordance with one or more embodiments;

FIG. 9 illustrates the results of an evaluation of the document transformation system using various configurations in accordance with one or more embodiments;

FIG. 10 illustrates a diagram of an example architecture of the document transformation system in accordance with one or more embodiments;

FIG. 11 illustrates a flowchart of a series of acts for generating a transformed document by combining source text, a document hierarchy, and named entity classifications in accordance with one or more embodiments; and

FIG. 12 illustrates a block diagram of an example computing device in accordance with one or more embodiments.

### DETAILED DESCRIPTION

This disclosure describes one or more embodiments of a document transformation system that generate targeted layouts from source documents utilizing language machine learning models with semantic hierarchical transformations. For example, the document transformation system automatically extracts key information from a source document, maps the extracted key information to positions within a target document, and transforms the mapped content to generate a transformed document. For example, the document transformation system utilizes a text classification model to build a document hierarchy for textual elements and corresponding text classes within the target document. As part of building the document hierarchy, the document transformation system maps the textual content into hierarchical sections within the document hierarchy. The document transformation system also utilizes an intent classification algorithm to generate named entity classifications for the textual content of the target document. Furthermore, the document transformation system extracts source text from the source document which includes key information relating to the content of the source document.

In one or more embodiments, the document transformation system generates the transformed document based on the source text from the source document, the named entity classifications, the text classes, and the document hierarchy. For example, the document transformation system utilizes the source document, the named entity classifications, the text classes, and the document hierarchy to generate a text transformation prompt for a language machine learning model. Based on the text transformation prompt, the document transformation system utilizes the language machine learning model to map text from the source document to the target document and generate the transformed document. In some cases, the document transformation system creates a transformed document with modified text from the source document that corresponds to the features and style of the target document. In some embodiments, the document transformation system generates a refined text transformation prompt by utilizing a prompt generation language machine learning model (using Bayesian optimization) to generate the transformed document.

As just mentioned, in some embodiments, the document transformation system utilizes a text classification model to build a document hierarchy for textual elements within a target document. For example, the document transformation system generates the document hierarchy based on a relative importance and organization of textual elements within the target document. Furthermore, the document transformation system determines corresponding text classes for the textual elements of the target document. In certain embodiments, the document transformation system sorts the textual content of the target document into hierarchical sections by classifying the textual content based on the text classes and the spatial coordinates of textual elements within the target document. In some cases, the document transformation system also utilizes an intent classification algorithm to generate named entity classifications for the textual content.

In some embodiments, the document transformation system maps textual content from the source document to the target document based on a text transformation prompt. In particular, the document transformation system utilizes source text from the source document, the named entity classifications, the text classes, and the document hierarchy to generate a text transformation prompt. The document transformation system utilizes the text transformation prompt as input to a language machine learning model to map textual content from the source document to the target document. In some cases, the document transformation system creates a transformed document with textual content that conforms to the features and style of the target document.

To elaborate, in one or more embodiments, the document transformation system iteratively populates the hierarchical sections of the target document based on the initial transformed document, the source text, the document hierarchy, and the named entity classifications. For example, the document transformation system utilizes a language machine learning model to generate an initial transformed document by populating a first section of the hierarchical sections of the target document based on source text of a source document, the document hierarchy, and the named entity classifications. In addition, the document transformation system utilizes the language machine learning model to generate a transformed document by iteratively populating additional sections of the hierarchical sections of the target document based on the previously populated sections as well as the source text, the document hierarchy, and the named entity classifications. In this way, the document transformation system structures the text generation to generate the transformed document by populating the target document in a cohesive top-down approach.

Furthermore, in certain embodiments, the document transformation system refines the text transformation prompt. For example, the document transformation system utilizes an additional language machine learning model (e.g., a query generation language machine learning model) to generate the text transformation prompt by refining an initial text transformation prompt based on a training source document and a training target document. For example, the document transformation system generates a refined prompt by utilizing the query generation language machine learning model and Bayesian optimization to generate the text transformation prompt for input to the language machine learning model.

As mentioned above, conventional systems have a number of technical shortcomings with regard to flexibility, accuracy, and operational efficiency when generating document transformations. In particular, many existing document creation systems are inflexible. For example, many existing document creation systems inflexibly limit the creation of transformed documents to specific genres and/or predefined document datasets (e.g., scientific research articles). Additionally, existing document creation systems often rigidly rely on layout optimization models that incorporate text inputs of limited length. Moreover, many existing document creation systems employ a static document transformation process that only transfers text from specific pre-defined fields (or based on previously used field values) from a source document to designated fields within a target document.

Relatedly, in addition to inflexibility, existing document creation systems also suffer from inaccuracies. In particular, many existing document creation systems lack the sophistication to generate a coherent transformed document based on a source document. For example, the rigid approach employed by existing document creation systems fails to account for the nuanced contextual relationships between parts of the document which leads to inaccurate textual selections and/or transformations. In addition, many existing document creation systems fail to accurately size the replacement text, often losing content (if reducing the size) or appearing sparce (if the length is too small).

In addition, the rigid text mapping of existing document creation systems causes deficiencies in operational efficiency. For example, many existing document creation systems do not automatically match the mapped textual content to the style of a target document. At least in part because of this rigidity, the existing document creation systems require additional device interactions to correct generated documents due to a failure to maintain visual harmony between textual elements in terms of style, size, and/or position. Furthermore, many existing document creation systems employ a step-by-step selection for source text (e.g., using predefined labels or fixed fields) to generate a target document which requires multiple device interactions to generate and/or select the source text.

As suggested above, embodiments of the document transformation system provide a variety of advantages over conventional document creation systems. For instance, the document transformation system improves flexibility when generating transformed documents. To illustrate, embodiments of the document transformation system flexibly extract the key elements from a document to automatically map content from a semi-structured document to a design template without requiring pre-determined labels or fixed field names. Furthermore, by determining a hierarchical relationship between elements (e.g., headings, subheadings, paragraphs and corresponding spatial arrangements), the document transformation system maps textual elements to templates without requiring target documents with an obvious reading order. Indeed, in contrast to conventional systems that do not account for the interrelationships between textual content within a source document, embodiments of the document transformation system generate transformed documents that are highly consistent with the interrelationships of the source document. Furthermore, the document transformation system flexibly extracts the key details from a variety of source documents (e.g., PDFs, long-form documents, brochures, guides, manuals, reports, articles, papers, webpages) into a selected template.

Furthermore, in one or more embodiments, the document transformation system provides improved accuracy over existing systems. For example, unlike many conventional systems that rigidly map text to a target document, embodiments of the document transformation system leverage language machine learning models to provide a transformed document with accurately interrelated content. For example, by utilizing named entity recognition and a document hierarchy, the document transformation system provides an effective method to map content and generate a transformed document based on analyzing contextual relationships between sections within the target document. Furthermore, by iteratively generating the text transformation prompt using a query generation language machine learning model, the document transformation system refines a high-quality prompt for a language machine learning model to more accurately integrate the source content into the target document.

In addition, embodiments of the document transformation system provide improved computational efficiency. Indeed, unlike many existing document creation systems that require excess device interactions to populate pre-defined labels or fixed fields, the document transformation system utilizes the document hierarchy to automatically maps textual content directly from the source document. For example, the invention extracts key information directly from a semi-structured source document without requiring excess device interactions to specify source textual content. Indeed, in certain embodiments, the document transformation system automatically extracts key information from a source document, maps the extracted information to relevant text elements in a target document, and transforms the extracted information match the style of the target document and generate a transformed document utilizing a language machine learning model. As a result, in one or more embodiments the document transformation system provides a marked reduction in the computational resources required-such as computational overhead associated with frequent user device interactions-leading to reduced time and computational resources.

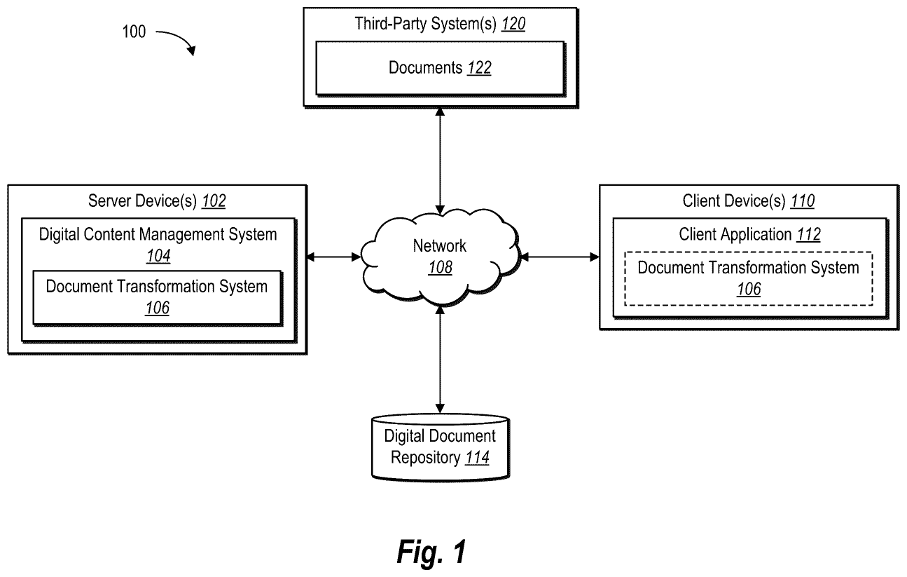

Additional detail regarding the document transformation system will now be provided with reference to the figures. For example, FIG. 1 illustrates a schematic diagram of an exemplary system environment (“environment”) 100 in which a document transformation system 106 operates. As illustrated in FIG. 1, the environment 100 includes server device(s) 102, a network 108, the client device(s) 110, the digital document repository 114, and the third-party system(s) 120.

Although the environment 100 of FIG. 1 is depicted as having a particular number of components, the environment 100 is capable of having any number of additional or alternative components (e.g., any number of servers, client devices, or other components in communication with the document transformation system 106 via the network 108). Similarly, although FIG. 1 illustrates a particular arrangement of the server device(s) 102, the network 108, the client device(s) 110, the digital document repository 114, and the third-party system(s) 120, various additional arrangements are possible.

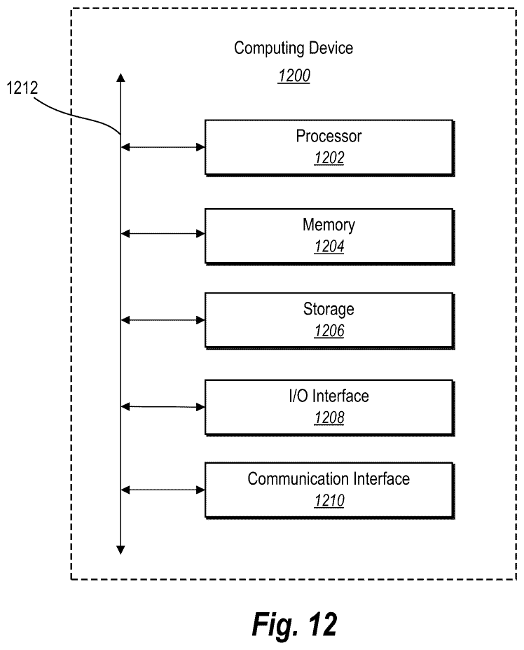

The server device(s) 102, the network 108, the client device(s) 110, the digital document repository 114, and the third-party system(s) 120 are communicatively coupled with each other either directly or indirectly (e.g., through the network 108 discussed in greater detail below in relation to FIG. 12). Moreover, the server device(s) 102 and client device(s) 110 include one of a variety of computing devices (including one or more computing devices as discussed in greater detail with relation to FIG. 12).

As illustrated in FIG. 1, the environment 100 includes the server device(s) 102 and digital content management system 104. The server device(s) 102 utilizes the digital content management system 104 to generate, track, store, process, receive, and transmit electronic data, including digital images and textual content. For example, the server device(s) 102 receives or monitors interactions across the client device(s) 110. In some embodiments, the server device(s) 102 transmits content to the client device(s) 110 to cause the client device(s) 110 to display content associated with transformed documents. For example, the server device(s) 102 presents source documents and target documents to client device(s) 110 and displays source documents, target documents, and transformed documents on the client device(s) 110 with the source documents, target documents, and transformed documents displayed according to system need (e.g., providing a transformed document for display via client application(s) 112).

Additionally, the server device(s) 102 includes all, or a portion of, the document transformation system 106. For example, the document transformation system 106 operates on the server device(s) 102 to access digital content (including images, documents, and textual content), determine digital content changes, and provide localization of content changes to the client device(s) 110. In one or more embodiments, via the server device(s) 102, the document transformation system 106 generates and displays images, documents, and textual content based on the client device(s) 110 input. Example components of the document transformation system 106 will be described below with regard to FIG. 12.

Furthermore, as shown in FIG. 1, the illustrated system includes the client device(s) 110. In some embodiments, the client device(s) 110 include, but are not limited to, mobile devices (e.g., smartphones, tablets), laptop computers, desktop computers, or another type of computing devices, including those explained below in reference to FIG. 12. Some embodiments of client device(s) 110 are operated by a user to perform a variety of functions via respective client application(s) 112 such as the generation and modification of transformed documents. The client device(s) 110 include one or more applications (e.g., the client application(s) 112) that access, edit, modify, store, and/or provide, for display, digital image content. For example, in some embodiments, the client application(s) 112 include a software application installed on the client device(s) 110. In other cases, however, the client application(s) 112 include a web browser or other application that accesses a software application hosted on the server device(s) 102.

In one or more embodiments, the document transformation system 106 is implemented in whole, or in part, by the individual elements of the environment 100. Indeed, as shown in FIG. 1, the document transformation system 106 is implemented with regard to the server device(s) 102 and the client device(s) 110. In particular embodiments, the document transformation system 106 on the client device(s) 110 comprises a web application, a native application installed on the client device(s) 110 (e.g., a mobile application, a desktop application, a plug-in application, etc.), or a cloud-based application where part of the functionality is performed by the server device(s) 102.

In additional or alternative embodiments, the document transformation system 106 on the client device(s) 110 represents and/or provides the same or similar functionality as described herein in connection with the document transformation system 106 on the server device(s) 102. In some embodiments, the document transformation system 106 on the server device(s) 102 supports the document transformation system 106 on the client device(s) 110.

In some embodiments, the document transformation system 106 includes a web hosting application that allows the client device(s) 110 to interact with content and services hosted on the server device(s) 102. To illustrate, in one or more embodiments, the client device(s) 110 accesses a web page or computing application supported by the server device(s) 102. The client device(s) 110 provides input to the server device(s) 102 (e.g., selected content items). In response, the document transformation system 106 on the server device(s) 102 generates/modifies digital content. The server device(s) 102 then provides the digital content to the client device(s) 110.

In some embodiments, the document transformation system 106 includes the third-party system(s) 120 and the documents 122. To illustrate, in one or more embodiments, the document transformation system 106 interacts with content and services hosted on the third-party system(s) 120. To illustrate, in one or more embodiments, the document transformation system 106 accesses a web page or computing application supported by the third-party system(s) 120. The third-party system(s) 120 provide input to the document transformation system 106 (e.g., language machine learning model prompts) and documents 122 (e.g., source documents, target documents, and transformed documents). In response, the document transformation system 106 generates/modifies digital content including generating transformed documents. The document transformation system 106 then provides the digital content to the third-party system(s) 120.

In another embodiment, the document transformation system 106 on the server device(s) 102 supports the document transformation system 106 on the client device(s) 110. For instance, in some cases, the document transformation system 106 on the server device(s) 102 generates or learns parameters for one or more machine learning models (e.g., a language machine learning model, a natural language query generation model, and a text generator language machine learning model). The document transformation system 106 then, via the server device(s) 102, provides the one or more trained machine learning models to the client device(s) 110. In other words, the client device(s) 110 obtains (e.g., downloads) the one or more machine learning models (e.g., with any learned parameters) from the server device(s) 102. Once downloaded, the one or more machine learning models on the client device(s) 110 utilizes the one or more trained machine learning models to generate transformed documents independent from the server device(s) 102.

In some embodiments, though not illustrated in FIG. 1, the environment 100 has a different arrangement of components and/or has a different number or set of components altogether. For example, in certain embodiments, the client device(s) 110 communicate directly with the server device(s) 102, bypassing the network 108. As another example, the environment 100 includes a third-party server comprising a content server and/or a data collection server.

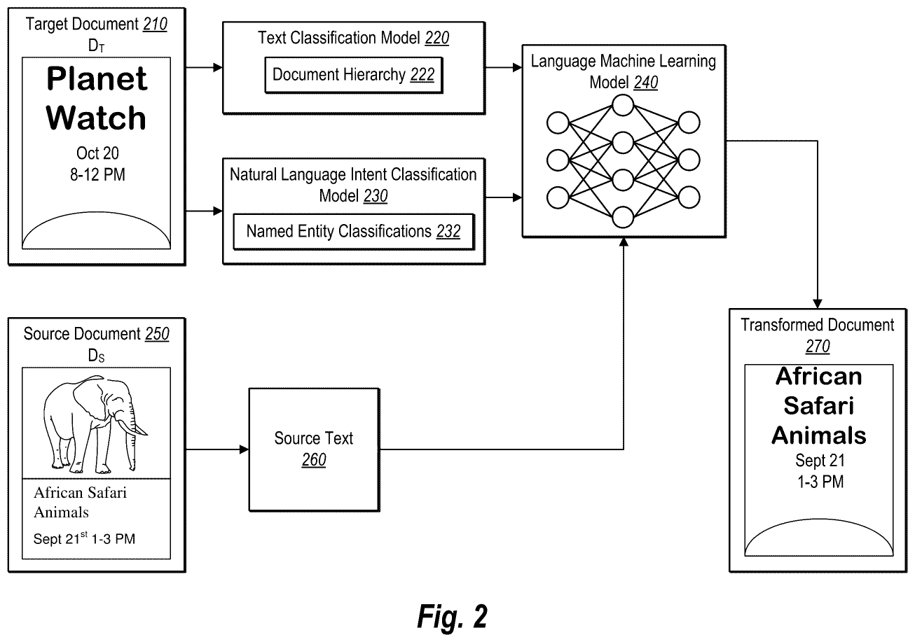

As previously mentioned, in one or more embodiments, the document transformation system 106 transforms digital design content utilizing language machine learning models to generate transformed documents. For instance, FIG. 2 illustrates an example overview of mapping a source document to a target document utilizing a language machine learning model in accordance with one or more embodiments. Additional detail regarding the various acts of FIG. 2 is provided thereafter with reference to subsequent figures.

As shown in FIG. 2, the document transformation system 106 replaces textual content of the target document 210 (D_{T}) based on the textual content of the source document 250 (D_{S}) to generate a transformed document 270. In particular, the document transformation system 106 extracts text semantics [symbol] (e.g., document hierarchy 222 and named entity classifications 232) of the target document 210. For example, the document transformation system 106 utilizes a text classification model 220 and a natural language intent classification model 230 to extract the text semantics [symbol] of the target document 210. In turn, the document transformation system 106 populates the target document 210 (D_{T}) with information from the source document 250 (D_{S}) by providing the text semantics [symbol] to a language machine learning model 240 to generate the transformed document 270.

To illustrate, in one or more embodiments, the document transformation system 106 analyzes the target document 210 to generate the document hierarchy 222 and the named entity classifications 232. As shown, the document transformation system 106 receives, identifies, or accesses the target document 210 (e.g., through a client device interaction). For example, the target document 210 includes a digital document comprising digital visual content (e.g., text and/or digital images). For instance, the target document 210 can include semi-structured document that includes a layout and/or structure to present and format the visual content (e.g., titles, headings, text blocks, bullet points). For example, the target document 210 includes a semi-structured document that does not require a specific reading order (e.g., top to bottom, left to right). To illustrate, the target document 210 includes a logical and coherent arrangement of textual elements including spacing, alignment, style, font, and size. As shown, the target document 210 includes one or more identifiable elements or textual sections that can be distinctly identified as titles, content sections, and/or headings designed to ensure consistency and to match the desired presentation style of the target document.

As further shown, in one or more embodiments, the document transformation system 106 generates the document hierarchy 222 from the target document 210 utilizing a text classification model 220. For example, the document transformation system 106 utilizes the text classification model 220 to generate the document hierarchy 222 for the target document 210 (D_{T}) based on the distance between text elements and the corresponding text classes (e.g., title, subtitle, bodytext). In certain cases, the text classification model 220 generates the document hierarchy 222 comprising semantically coherent sections from the target document 210. For example, when populating a resume, the document transformation system 106 populates the textual content in semantically coherent sections where all work experience is placed under the “Work Experience” section. In some cases, the text classification model 220 determines a relative importance and organization of textual elements within the target document 210, such as visual elements, content sections, or information blocks to generate the document hierarchy 222. In some embodiments the text classification model 220 organizes the textual elements into hierarchical sections according to text classes. The document transformation system 106 arranges textual content of the target document 210 within the document hierarchy 222 into hierarchical sections based on the text classes and spatial coordinates of the textual elements within the target document.

In addition, in some embodiments, the document transformation system 106 identifies named entities in the target document 210 (D_{T}). For example, the document transformation system 106 generates the named entity classifications 232 (e.g., NER tags) from the target document 210 utilizing a natural language intent classification model 230. For example, the document transformation system 106 utilizes the natural language intent classification model 230 to identify and classify named entities within the target document 210. To illustrate, if the target document 210 is an invitation, the document transformation system 106 identifies a “location tag” to map information to the transformed document 270. In some cases, the natural language intent classification model 230 utilizes dependencies and context within the target document 210 to extract relevant features from the textual content, analyze the relevant features, and generate the named entity classifications 232.

In one or more embodiments, the document transformation system 106 utilizes the natural language intent classification model 230 to determine the named entity classifications 232. The document transformation system 106 can utilize a variety of named entity classifications indicating groups or classes of entities extracted from text in a document. In particular, the named entity classifications 232 can include class labels identifying particular types of named entities referenced in the text of a target document. For example, in some implementations, the document transformation system can utilize the following named entity classifications and corresponding definitions: “CARDINAL”: Number; “DATE”: Date or Time period; “EVENT”: Named Event; “FAC”: Buildings and Infrastructure; “GPE”: location; “LANGUAGE”: Language; “LAW”: Named documents made into laws; “LOC”: locations, mountain ranges, bodies of water; “MONEY”: prices; “NORP”: Nationalities or religious or political groups; “ORDINAL”: ranks/numerical positions; “ORG”: Organization Name; “PERCENT”: Percentage, including %, “PERSON”: Named Person; “PRODUCT”: Product; “QUANTITY”: Measurements; “TIME”: Times smaller than a day; “WORK_OF_ART”: Titles of books, songs, etc.; “CONTACT”: phone numbers or addresses and/or additional classifications.

As further shown, the document transformation system 106 determines or receives a source document 250 (D_{S}) to generate the transformed document 270. A source document can include a digital file that includes digital visual content (e.g., digital image and/or digital text). For example, the document transformation system 106 utilizes the source document 250 that includes a long-form document, report, article, guide, manual, legal document, presentation, PDF, and/or memorandum. In some cases, the source document 250 includes a semi-structured document with structured elements (e.g., specific fields, tags, labels) and unstructured elements (e.g., freeform text, paragraphs), an unstructured document with unstructured elements, or a structured document with structured sections and sub-sections.

As further shown, the document transformation system 106 extracts source text 260 from the source document 250 (D_{S}). In particular, the document transformation system 106 automatically extracts key information from textual elements within the source document 250 to generate the source text 260. In some cases, the document transformation system 106 generates the source text 260 by identifying key phrases and terms that are relevant to the context of the source document 250. In certain cases, the document transformation system 106 generates the source text 260 by utilizing one or more machine learning models to capture semantic relationships between different parts of the textual content of the source document 250. In some cases, the document transformation system 106 generates the source text 260 by transforming and/or summarizing the text from the source document 250.

As further shown, the document transformation system 106 populates the target document 210 (D_{T}) to generate the transformed document 270 based on the text semantics S (e.g., the document hierarchy 222 and the named entity classifications 232) of the target document 210 and the source text 260. In particular, the document transformation system 106 prompts the language machine learning model 240 to generate the transformed document 270. For example, the document transformation system 106 utilizes the language machine learning model 240 to generate the transformed document 270 based on the source text 260, the named entity classifications 232, and the document hierarchy 222. In particular, the document transformation system 106 utilizes the language machine learning model 240 to map the source text 260 to replace content within the target document 210 based on the document hierarchy 222 and the named entity classifications 232. In some cases, the document transformation system 106 generates the transformed document 270 by integrating the source text 260 into the transformed document 270 formatted according to the format and/or style of the target document 210.

In some embodiments, the language machine learning model 240 (e.g., a large language model) includes or refers to a machine learning model trained to perform computer tasks to generate textual content (e.g., to populate the transformed document 270). A machine learning model includes a computer algorithm or a collection of computer algorithms that can be trained and/or tuned based on inputs to approximate unknown functions. For example, a machine learning model can include a computer algorithm with branches, weights, or parameters that change based on training data to improve for a particular task. Thus, a machine learning model can utilize one or more learning techniques (e.g., supervised or unsupervised learning) to improve in accuracy and/or effectiveness. Example machine learning models include various types of decision trees (e.g., gradient boost models), support vector machines, Bayesian networks, random forest models, or neural networks (e.g., deep neural networks, generative adversarial neural networks, convolutional neural networks, recurrent neural networks, or diffusion neural networks). Similarly, as used herein, a neural network refers to a machine learning model of interconnected nodes (or neurons) organized into layers. A neural network can include parameters or weights between neurons that are adjusted during training to minimize the error (or measure of loss) in generating predictions.

A language machine learning model includes a neural network (e.g., a deep neural network) that analyzes a language input to generate a predicted output. For example, a language machine learning model includes a neural network that generates a text response based on an input text query. In some cases, the language machine learning models utilize a transformer architecture, which includes mechanisms such as self-attention, to capture contextual relationships in the data.

Along these lines, the language machine learning models are trained and/or fine-tuned based on a diverse text corpora to perform natural language processing tasks, such as text generation, translation, summarization, and question answer generation. For example, the language machine learning models, consist of layers of interconnected artificial neurons organized in encoder and decoder blocks, which learn complex language patterns to generate textual content. For example, the language machine learning models include models such as Vicuna, GPT (Generative Pre-trained Transformer), BERT (Bidirectional Encoder Representations from Transformers), T5 (Text-To-Text Transfer Transformer), LLAMA, or similar architectures that utilize self-attention mechanisms in natural language understanding and generation.

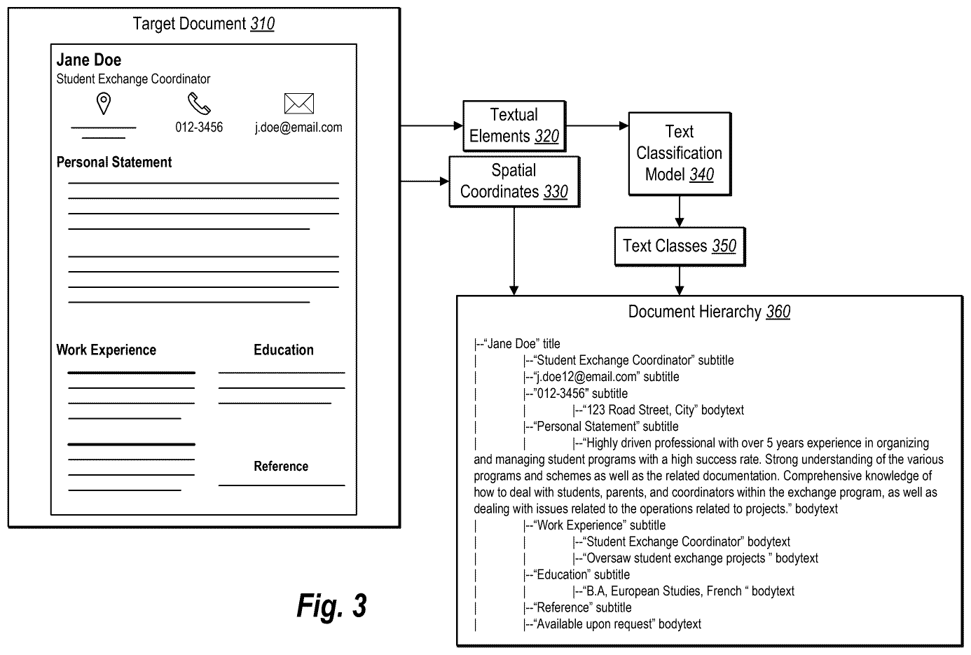

As mentioned, in some implementations, the document transformation system 106 generates a document hierarchy and then utilizes the document hierarchy with a language machine learning model to generate a transformed document from a target document. FIG. 3 illustrates an example of generating a document hierarchy for a target document in accordance with one or more embodiments.

As shown in FIG. 3, the document transformation system 106 receives and/or determines a target document 310. For example, the document transformation system 106 can receive the target document 310 from a client device (e.g., based on user interaction with a selectable option via a user interface). As shown, the document transformation system 106 determines textual elements 320 within the target document 310. In particular, the document transformation system 106 determines textual elements 320 that include discrete textual components or textual structures within the target document 310. In certain cases, the textual elements 320 include distinct sections of a document or textual content such as headings, paragraphs, bullet points, footnotes, captions, and/or text blocks.

As further shown in FIG. 3, the document transformation system 106 determines spatial coordinates 330 corresponding to the locations of the textual elements 320 within the target document 310. As used herein, the spatial coordinates 330 refer to locations within the target document 310. In some cases, the document transformation system 106 calculates a bounding box which delineates the spatial coordinates 330 of the textual elements 320 within the target document 310. In some cases, the document transformation system 106 determines the spatial coordinates 330 based on positional relationships (e.g., adjacent, nested, aligned, proximate, overlapped) between textual elements 320 within the target document 310.

As further shown, the document transformation system 106 utilizes the text classification model 340 to generate text classes 350 that correspond to the textual elements 320 within the target document 310. The document transformation system 106 can utilize a variety of computer algorithms for the text classification model 340 to generate text classes. For example, in some implementations, the document transformation system 106 utilizes a trained machine learning model (e.g., classification model such as a convolutional neural network) to generate a predicted text class from an input textual element. In particular, the document transformation system 106 can train a text classification model by analyzing training textual elements to generate predicted text classes. The document transformation system 106 can compare the predicted text classes with ground truth classes to determine a measure of loss and then modify parameters of the text classification model to iteratively improve predicted classification accuracy.

In some implementations, the document transformation system 106 utilizes a heuristic model that applies one or more contextual rules to generate a text class. For instance, the document transformation system 106 can utilize a heuristic model that analyzes location, size, font, style, length, text content, or other features based on contextual rules (e.g., size thresholds, location thresholds, font type categories, natural language flags) to generate a text class. To illustrate, a textual element of a threshold spatial size below a threshold length, with an all capital font style can be classified as a Title.

In some embodiments, the text classification model 340 generates the text classes 350 by assigning categories or labels to segments of text based on the content, purpose, or function of the textual content. In some cases, the text classification model 340 utilizes contextual rules or processing steps to determine the text classes 350 based on the overall structure of the target document 310 (e.g., ensuring there is only one main title per page, titles should precede body text). To illustrate, the document transformation system 106 generates a labeled dataset by associating text classes 350 with corresponding textual elements 320 (e.g., “title,” “subtitle,” “heading,” “subheading,” “section title,” “bodytext,” “bullet,” “list,” “footnote”).

As further shown, in one or more embodiments, the document transformation system 106 utilizes the spatial coordinates 330 and the text classes 350 from the text classification model 340 to build a document hierarchy 360 comprising the textual elements 320 organized into hierarchical sections. In some cases, the document transformation system 106 generates the document hierarchy 360 based on a relative importance and organization of the textual elements 320 within the target document 310. In some embodiments, the document transformation system 106 determines parent and child nodes (e.g., nodes organized into hierarchical sections) corresponding to textual elements within the document hierarchy 360.

For example, in one or more embodiments the document transformation system 106 generates the document hierarchy 360 by mapping the textual elements 320 to the document hierarchy 360 based on the text classes 350 and the spatial coordinates 330. In some cases, the document transformation system 106 initializes a document tree and populates the root node with the textual element from the target document 310 corresponding to the title. In addition, the document transformation system 106 iteratively populates additional nodes, prioritizing higher priority classes first (e.g., titles before subtitles, subtitles before bodytext). In some cases, the document transformation system 106 processes the textual elements 320 based on the spatial coordinates 330 (e.g., from top to bottom, left to right). In this way, the document transformation system 106, adds the textual elements 320 to the closest existing element in the tree, generating the hierarchical structure.

In one or more embodiments, the text classification model 340 generates the document hierarchy 360 as follows:

```
# Sort textual elements based on text classes (high priority first),
# descending order of Y coordinates and
# ascending order of X coordinates.
T = DocumentTree(texts) # initialize
for text in texts:
  if hier2id[text[“hier”]] == 0: # Title
    T.addHier(T.root, text)
    Continue
      # ClosestInTree returns the element present in the tree that
      # is closest to the given element.
  T.addHier(T.closestInTree(text), text)
      # addHier(parent, child) adds the child to the parent if it the parent
      is higher in hierarchy compared to child. If not, recursively call
      addHier(parent.parent, child).
return T
```

Indeed, the text classification model 340 generates the document hierarchy 360 comprising the textual elements 320 from the target document 310 based on organizing the corresponding text classes 350 and the spatial coordinates 330 into the hierarchical sections. To illustrate, as shown in FIG. 3, the text classification model 340 generates the document hierarchy 360 for the target document 310 as follows:

```
--“Jane Doe” title
  --“Student Exchange Coordinator” subtitle
  --“j.doe@gmail.com” subtitle
  --“012-3456” subtitle
    --“123 Road Street, City” bodytext
  --“Personal Statement” subtitle
    --“Highly driven professional with over 5 years experience in organizing
  and managing student programs with a high success rate. Strong understanding of
  the various programs and schemes as well as the related documentation.
  Comprehensive knowledge of how to deal with students, parents and coordinators
  within the exchange program, as well as dealing with issues related to the
  operations related to projects.” bodytext
  --“Work Experience” subtitle
    --“Student Exchange Coordinator” bodytext
    --“Oversaw student exchange projects” bodytext
  --“Education” subtitle
    --“B.A, European Studies, French” bodytext
  --“Reference” subtitle
    --“Available upon request” bodytext
```

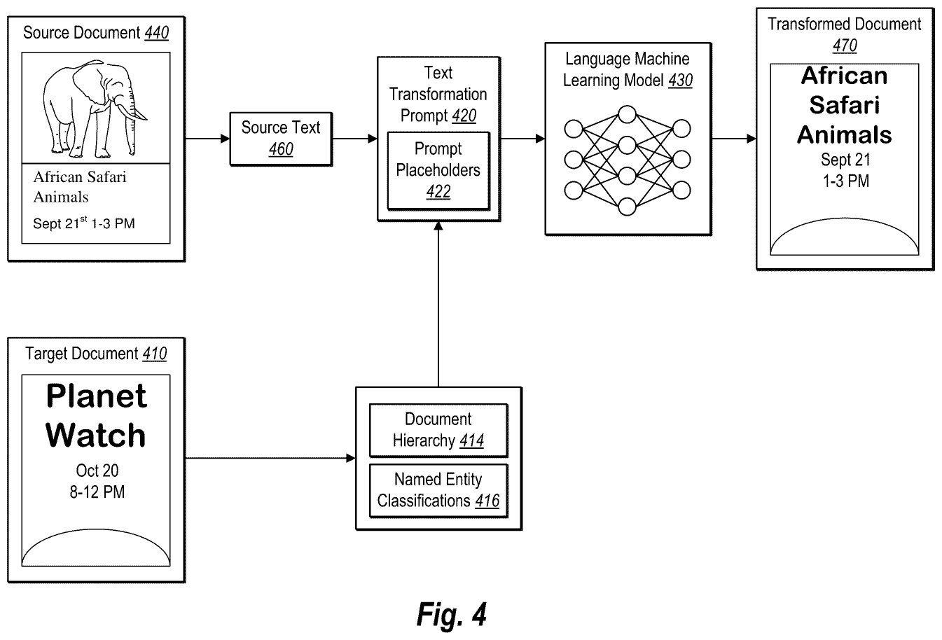

FIG. 4 illustrates an example of utilizing a text transformation prompt to generate a transformed document in accordance with one or more embodiments. As discussed above and shown in FIG. 4, the document transformation system 106 generates the text transformation prompt 420 utilizing a document hierarchy 414 and named entity classifications 416.

As shown, in some cases, the document transformation system 106 incorporates prompt placeholders 422 that act as variables for replacing content within the text transformation prompt 420. For example, the document transformation system 106 determines the prompt placeholders 422 within the text transformation prompt 420 for creating a transformed document 470 from a target document 410 and a source document 440. In particular, the document transformation system 106 utilizes the source text 460, the document hierarchy 414, and the named entity classifications 416 to fill in the prompt placeholders 422 within the text transformation prompt 420. In some embodiments, the document transformation system 106 replaces the prompt placeholders 422 by dynamically inserting content into the text transformation prompt 420.

In one or more embodiments, the document transformation system 106 generates the text transformation prompt 420 by incorporating instructions to maintain word counts for textual elements of the transformed document 470 based on word counts for the textual elements of the target document 410. For example, the document transformation system 106 generates instructions to maintain a word count (e.g., number of words) for each textual element of the transformed document 470 corresponding to a target word count for the textual elements within the target document 410 (e.g., within a threshold number of words). In some cases, the document transformation system 106 generates instructions to maintain a character count (e.g., number of characters) for each textual element of the transformed document 470 corresponding to a target character count for the textual elements within the target document 410 (e.g., within a threshold number of characters). By incorporating instructions to maintain word counts and/or character counts when generating the text transformation prompt, the document transformation system 106 generates the transformed document 470 that visually corresponds to the textual elements in the target document 410.

In some cases, the document transformation system 106 generates instructions to maintain text styles for each textual element of the transformed document 470. For example, the document transformation system 106 generates instructions to generate a text font (e.g., color, spacing, alignment, emphasis) for the transformed document 470 based on the target text font of the corresponding textual elements within the target document 410. In certain cases, the document transformation system 106 generates instructions to generate text styles that maintain a textual tone (e.g., formal, informal, conversational, persuasive, neutral, humorous) corresponding to a textual tone for textual elements of the transformed document 470 based on the textual tone for the textual elements of the target document 410. By incorporating instructions to maintain text styles when generating the text transformation prompt, the document transformation system 106 generates the transformed document 470 that maintains a consistent tone and/or visual impact with the target document 410.

As shown, the document transformation system 106 provides the text transformation prompt 420 to the language machine learning model 430 to generate the transformed document 470. Based on the text transformation prompt 420, the language machine learning model 430 generates the transformed document 470 by populating the target document 410 with source text 460 extracted and/or generated from the source document 440 utilizing the on document hierarchy 414 and named entity classifications 416.

To illustrate, the document transformation system 106 identifies target document placeholder fields that correspond to areas within the target document and/or encompass textual elements within the target document 410 based on the document hierarchy 414. In some cases, the document transformation system 106 generates the text transformation prompt 420 comprising instructions for the language machine learning model 430 to map textual elements from the source text 460 to the target document 410 (e.g., to the target document placeholder fields) based on the source text 460, the document hierarchy 414, and the named entity classifications 416. In turn, the document transformation system 106 replaces the textual elements within the target document 410 (e.g., within the target document placeholder fields) based on the mapping from the language machine learning model 430. In some cases, the document transformation system 106 generates the text transformation prompt 420 comprising instructions to the language machine learning model 430 to replace the textual elements within the target document 410 (e.g., within the target document placeholder fields) based on the source text 460, the document hierarchy 414, and the named entity classifications 416 to generate the transformed document 470.

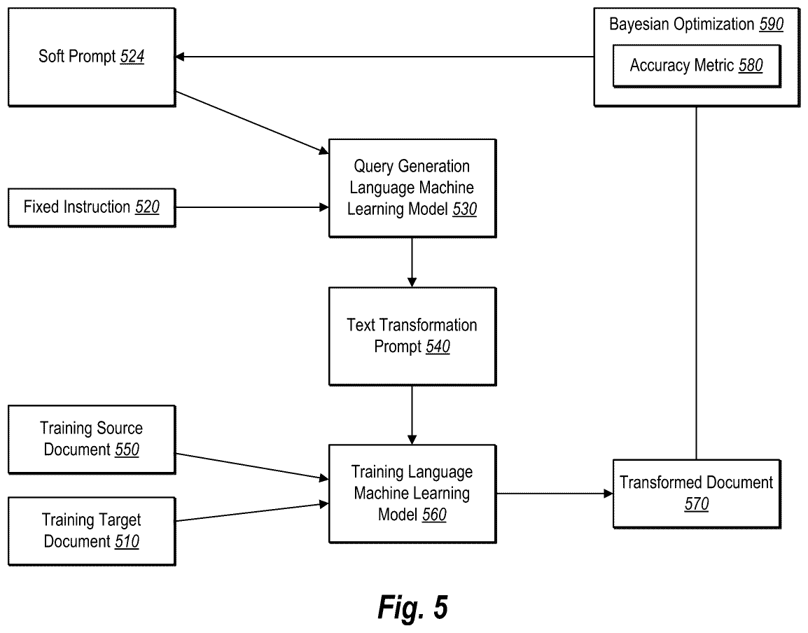

As mentioned, the document transformation system 106 utilizes a query generation language machine learning model to generate a text transformation prompt by refining an initial text transformation prompt. FIG. 5 illustrates an example of refining a text transformation prompt in accordance with one or more embodiments.

As shown in FIG. 5, the document transformation system 106 generates the text transformation prompt 540 from the soft prompt 524 based on the fixed instruction 520. Furthermore, the document transformation system 106 iteratively provides the text transformation prompt 540 to the query generation language machine learning model 530 to generate the text transformation prompt 540. In turn, the training language machine learning model 560 generates the transformed document 570 using zero-shot evaluation. In addition, the document transformation system 106 evaluates the transformed document 570 to generate an accuracy metric 580. The document transformation system 106 iteratively utilizes the Bayesian optimization 590 to generate the soft prompt 524, the query generation language machine learning model 530 to generate the text transformation prompt 540 and the training language machine learning model 560 to generate the transformed document 570 until the transformed document 570 satisfies a threshold accuracy for the accuracy metric 580.

To elaborate, as shown in FIG. 5, the document transformation system 106 fine-tunes the text transformation prompt 540 using the query generation language machine learning model 530, the training language machine learning model 560, and Bayesian optimization 590. In particular, the document transformation system 106 utilizes the query generation language machine learning model 530 to refine the text transformation prompt 540 based on the fixed instruction 520 and the soft prompt 524. In some cases, the query generation language machine learning model 530 refines the soft prompt 524 by adjusting the content, tone, style, clarity, or level of detail of the soft prompt 524.

As further shown, in one or more embodiments, the document transformation system 106 provides the text transformation prompt 540 to the training language machine learning model 560 to generate the transformed document 570. In some cases, the document transformation system 106 utilizes the language machine learning model 240 as the training language machine learning model 560. In some cases, the document transformation system 106 utilizes a separate language machine learning model as the training language machine learning model 560.

In some embodiments, the document transformation system 106 provides the text transformation prompt 540 to the training language machine learning model 560 to generate the transformed document 570 based on a training target document 510 and a training source document 550. In some cases, the document transformation system 106 utilizes the training language machine learning model 560 to generate the transformed document 570 using zero-shot evaluation. In some cases, the document transformation system 106 populates fields of the training target document 510 with source text generated from the training source document 550 based on the text transformation prompt 540 to generate the transformed document 570.

As shown, in certain embodiments, the document transformation system 106 iteratively refines the text transformation prompt 540 utilizing Bayesian optimization. In particular, the document transformation system 106 performs Bayesian optimization 590 to maximize the accuracy metric 480 and generate a modification to the soft prompt 524. In one or more embodiments, the document transformation system 106 utilizes Bayesian optimization to iteratively generate the text transformation prompt 540 utilizing a method similar to that described by Lichang Chen, Jiuhai Chen, Tom Goldstein, Heng Huang, and Tianyi Zhou in “InstructZero: Efficient Instruction Optimization for Black-Box Large Language Models,” 2023, incorporated by reference herein in its entirety. The document transformation system 106 iteratively utilizes the Bayesian optimization 590 to generate the soft prompt 524, the query generation language machine learning model to generate the text transformation prompt 540, and the training language machine learning model 560 to generate the transformed document 570 until the transformed document 570 satisfies a threshold accuracy for the accuracy metric 580.

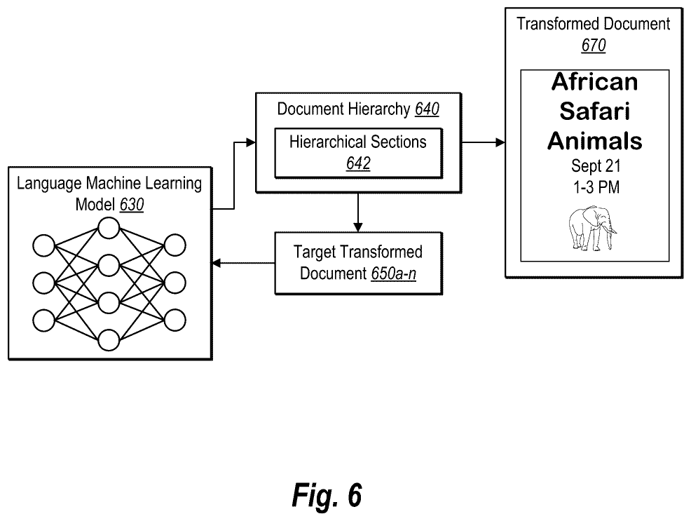

In one or more embodiments, the document transformation system 106 utilizes a document hierarchy to provide a structured approach to generating a transformed document. Moreover, in some implementations, the document transformation system 106 iteratively replaces hierarchical sections of a document hierarchy to generate a target document. For example, FIG. 6 illustrates an example of iteratively mapping textual content to hierarchical sections of a document hierarchy generate the transformed document in accordance with one or more embodiments.

In some embodiments, after fine-tuning the text transformation prompt, the document transformation system 106 utilizes the text transformation prompt to generate transformed documents. As shown in FIG. 6, in some embodiments, the document transformation system 106 generates the transformed document 670 utilizing iterative-based generation to iteratively add textual content from the source document into a target transformed document 650a-n. For example, the document transformation system 106 iteratively traverses the document hierarchy 640 to populate the hierarchical sections 642.

By utilizing iterative-based generation, the document transformation system 106 leverages the document hierarchy 640 to generate the transformed document 670. In particular, the document transformation system 106 prioritizes generating the textual content for higher level sections (e.g., parent sections) of the document hierarchy 640. Using this sequential process, the document transformation system 106 utilizes the textual content generated for higher level sections to generate the textual content for lower level sections. By prioritizing the higher level sections of the hierarchical sections 642, the document transformation system 106 enhances the readability and organization of the transformed document 670. Indeed, by first integrating the contextual information within the higher level sections, the document transformation system 106 significantly enhances the overall coherence across different sections of the transformed document 670.

To illustrate, the document transformation system 106 utilizes a language machine learning model 630 to generate the transformed document 670 utilizing iterative-based generation. As shown, the document transformation system 106 generates an initial transformed document (e.g., target transformed document 650a) by populating a first section of the hierarchical sections 642 of the target document based on the source text, the named entity classifications, and the document hierarchy. Subsequently, the document transformation system 106 generates a second transformed document (e.g., target transformed document 650b) by populating a second section of the hierarchical sections 642 based on the content of the target transformed document 650a (i.e., including the new content for the first section generated in the first iteration), the source text, the named entity classifications, and the document hierarchy. Similarly, the document transformation system 106 generates a third transformed document (e.g., target transformed document 650c) by populating a third section of the hierarchical sections 642 based on the target transformed document 650b (i.e., including the new content for the first section and the second generated in the first two iterations), the source text, the named entity classifications, and the document hierarchy. Similarly, the document transformation system 106 populates additional sections (e.g., fourth, fifth, etc.) of the hierarchical sections 642 by iteratively analyzing the document hierarchy 640 and utilizing the previously incorporated information (within the target transformed document 650a-n) to populate the additional sections.

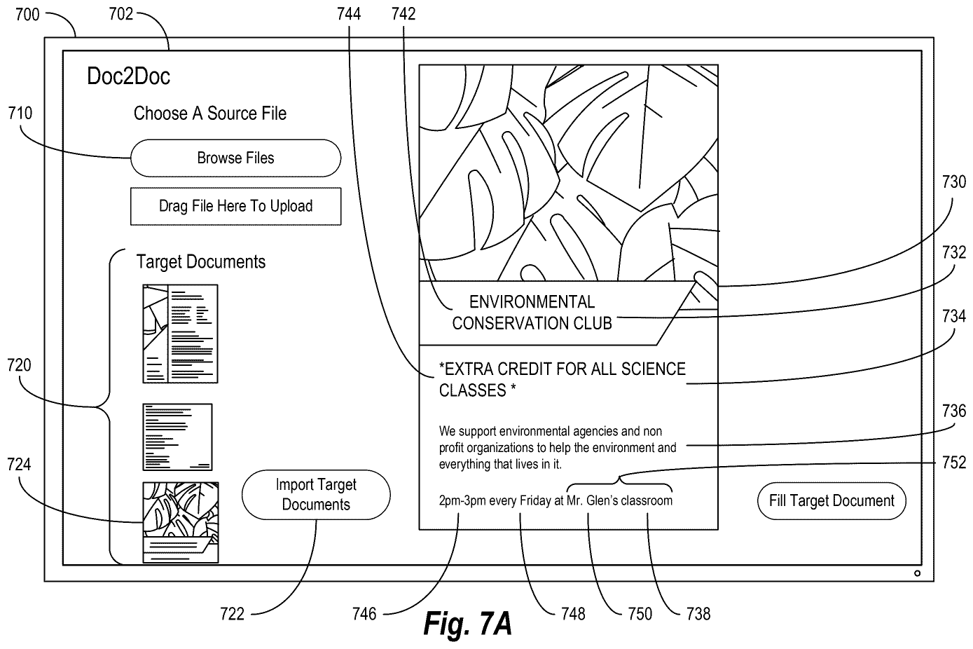

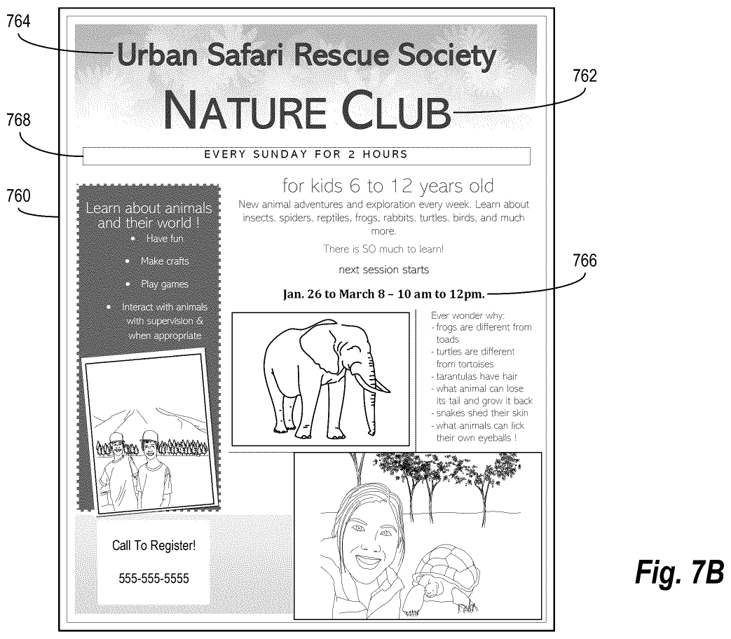

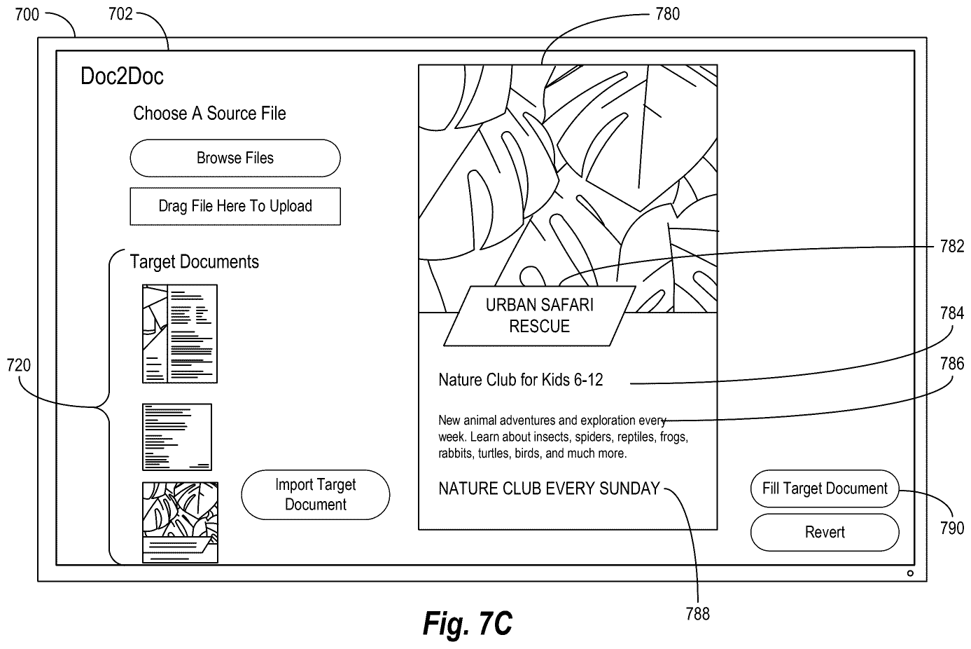

As mentioned previously, in one or more implementations, the document transformation system 106 provides an efficient, intuitive graphical user interface for generating transformed documents. FIGS. 7A-7C illustrate an example of utilizing the document transformation system 106 within a graphical user interface of a client device to generate a transformed document from a PDF source document in accordance with one or more embodiments.

As shown in FIG. 7A, the document transformation system 106 provides a graphical user interface 702 for display on a client device 700. In particular, the document transformation system 106 provides the graphical user interface 702 for generating a transformed document from a target document 730. As shown, the document transformation system 106 provides, for display on the client device 700, an element that includes target documents 720 selectable as target templates for generating transformed documents. In certain embodiments, the document transformation system 106 provides an import target documents option 722 to import, and analyze, an additional target document into the selection of target documents 720. The target documents 720 correspond to the target documents as described in relation to FIGS. 1-6.

To elaborate, the target documents 720 include a variety of target documents with content organized in diverse layouts, structures, and styles. For example, the target documents 720 include target documents with interrelated sections of content that incorporate elements such as titles, subtitles, headers, subheaders, paragraphs, body text, bullet points, lists, tables, charts, images, and/or summaries. For example, the target documents 720 include target documents styled as an advertisement, resume, poster, invitation, announcement, overview, or brochure.

As further shown, the document transformation system 106 provides the target document 730 for display in response to an interaction with the client device 700 to select target option 724. The document transformation system 106 determines the target document 730 includes textual elements organized and displayed in separate sections. As described above, the document transformation system 106 determines a hierarchical structure for the textual elements of the target document 730 which includes a title 732, subtitle 734, bodytext 736, and tagline 738. Furthermore, the document transformation system 106 determines named entity classifications for named entities present in the textual elements of the target document 730. For example, the document transformation system 106 determines the target document 730 includes named entity classifications of ORG 742 (e.g., “ENVIRONMENTAL CONSERVATION CLUB”), EVENT 744 (e.g., “EXTRA CREDIT FOR ALL SCIENCE CLASSES”), TIME 746 (e.g., “2 pm-3 pm”), DATE 748 (e.g., “every Friday”), PERSON 750 (e.g., “Mr. Glen”), and FAC 752 (e.g., “Mr. Glen's classroom”).

As further shown in FIG. 7B, the document transformation system 106 receives, determines, and/or selects a source document (e.g., source document 760) based on a client device interaction with selection option 710. As discussed above, the document transformation system 106 selects and/or generates source text from the source document 760 to populate the target document 730. In some cases, the document transformation system 106 utilizes the document hierarchy and the named entity classifications for the target document 730 to populate placeholder fields of the target document 730 utilizing source text from the source document 760.

Furthermore, as shown in FIG. 7C, in response to an interaction with the fill target documents option 790, the document transformation system 106 generates the transformed document 780. As described above, the document transformation system 106 generates the transformed document 780 based on the source text, the document hierarchy, and the named entity classifications. Indeed, the document transformation system 106 populates textual elements (e.g., placeholders) of the transformed document 780 with textual content generated from the source document 760.

For example, the document transformation system 106 utilizes a language machine learning model to replace sections of the target document 730 (e.g., the title 732, the subtitle 734, the tagline 738, and the bodytext 736) and generate the transformed document 780 using direct generation based on the text transformation prompt. To illustrate, turning to FIG. 7C, the document transformation system 106 generates textual content for the title 782, the subtitle 784, the tagline 788, and the bodytext 786 within the transformed document 780.

In one or more embodiments, the document transformation system 106 utilizes a language machine learning model to populate the transformed document using iterative-based generation. For example, the document transformation system 106 utilizes a language machine learning model to iteratively populate the placeholders within the target document 730 starting at the higher level sections and iteratively filling in lower level sections (e.g., the title 732, the subtitle 734, the tagline 738, and the bodytext 736). To illustrate, turning to FIG. 7C, the document transformation system 106 generates the content for the title 782 in the first iteration, the subtitle 784 in second iteration, the tagline 788 in the third iteration, and the bodytext 786 in the fourth iteration.

For example, the document transformation system 106 populates the target document 730 with source text generated from the source document 760. For example, the document transformation system 106 prompts the language machine learning model to generate textual content from the source document 760 to populate the target document 730 (e.g., populate placeholders) based on the document hierarchy of the target document 730 and the named entity classifications. To illustrate, the document transformation system 106 generates textual content for title 762 (e.g., “NATURE CLUB”), subtitle 764 (e.g., “Urban Safari Rescue Society”), time 766 (e.g., “10 am to 12 pm”), date 768 (e.g., “every Sunday”). As shown in FIGS. 7A-7C, the document transformation system 106 populates the target document 730 to generate the transformed document 780.

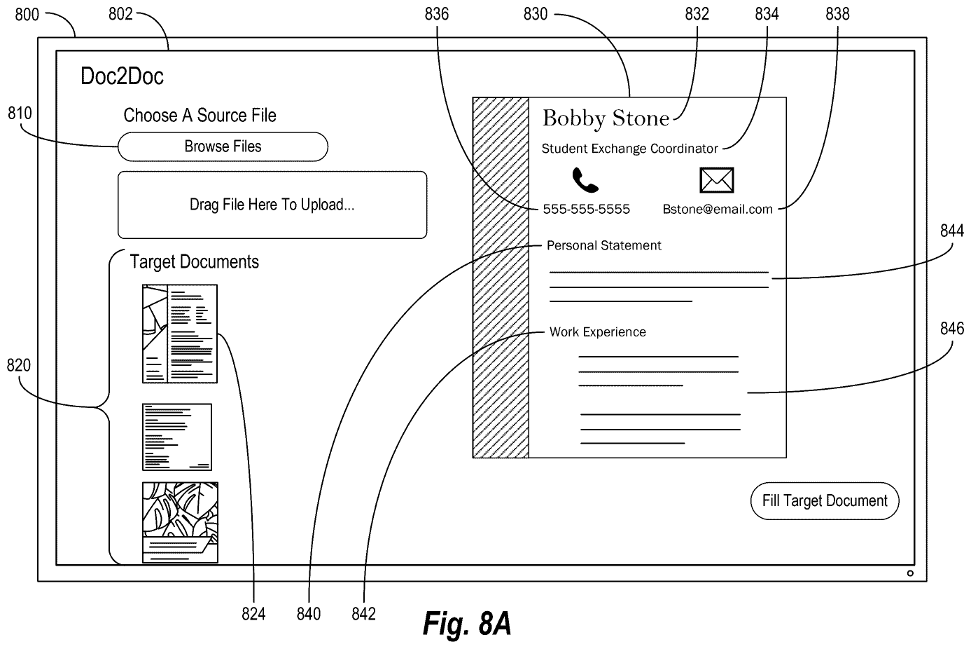

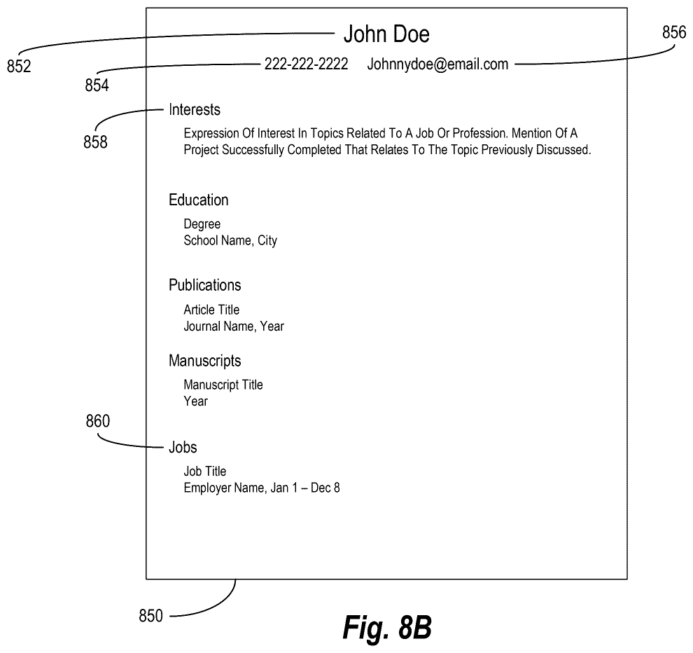

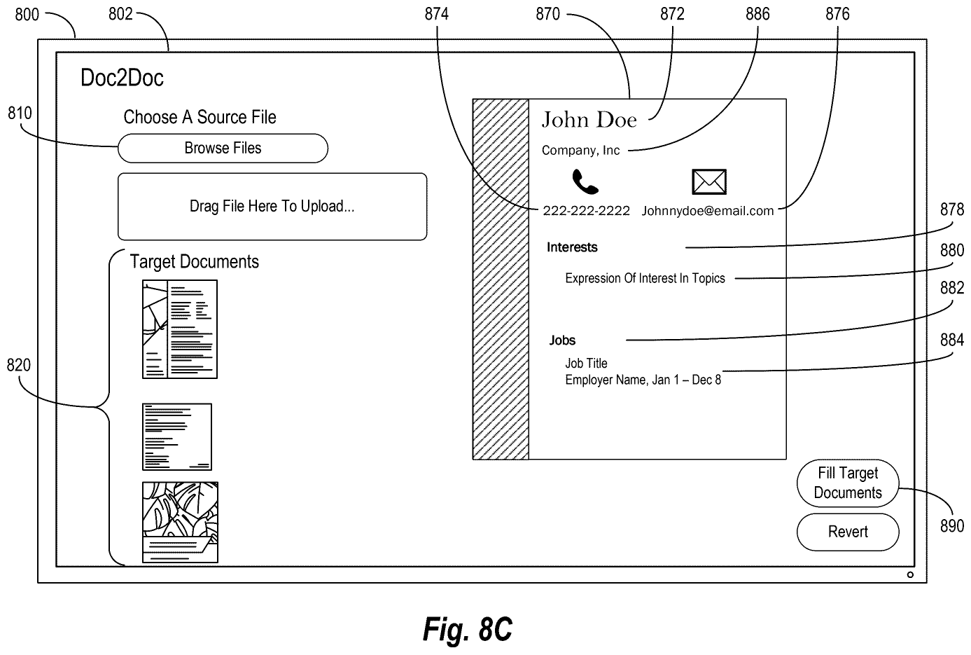

As mentioned, the document transformation system 106 generates transformed documents from a variety of source document including PDFs, long-form documents, brochures, guides, manuals, reports, articles, papers, and/or webpages. FIGS. 8A-8C illustrate an example of utilizing a document transformation system within a graphical user interface to generate a transformed document from a long-form document in accordance with one or more embodiments.

As shown in FIG. 8A, the document transformation system 106 provides a graphical user interface 802 for display on a client device 800. In particular, the document transformation system 106 provides the graphical user interface 802 to generate a transformed document from a target document 830. Similar to the description for FIGS. 7A-7C, the document transformation system 106 provides, for display on the client device 800, a selection of target documents 820 selectable as targets to generate transformed documents.

As further shown, the document transformation system 106 provides the target document 830 for display in response to an interaction with the client device 800 to select target option 824 from a selection of target documents 820. The document transformation system 106 determines the target document 830 includes textual elements organized and displayed in distinct sections, showcasing both a vertical and horizontal organization of the textual elements. In some cases, the target document 830 includes textual elements organized in a nested organization. To illustrate, the document transformation system 106 determines a hierarchical structure for the textual elements of the target document 830 which includes a title 832, subtitle 834, subheading 836, subheading 838, section title 840, section title 842, bodytext 844, and bodytext 846. Furthermore, the document transformation system 106 determines named entity classifications for named entities present in the textual elements of the target document 830. For example, the document transformation system 106 determines the target document 830 includes named entity classifications of PERSON (e.g., “Bobby Stone”), ORG (e.g., “Student Exchange Coordinator”), CONTACT1 (e.g., “455-455-5555”), CONTACT2 (e.g., “Bstone@email.com”), WORK_OF_ART1 (e.g., “Personal Statement”), and WORK_OF_ART2 (e.g., “Work Experience”).

As further shown in FIG. 8B, the document transformation system 106 receives, determines, and/or selects a source document (e.g., source document 850) based on a client device interaction with selection option 810. As discussed above, the document transformation system 106 selects and/or generates source text from the source document 850 to populate the target document 830 based on the document hierarchy and the named entity classifications.

Furthermore, as shown FIG. 8C, in response to an interaction with the fill target documents option 890, the document transformation system 106 generates the transformed document 870. As described above, the document transformation system 106 generates the transformed document 870 based on the source text, the document hierarchy, and the named entity classifications. In particular, the document transformation system 106 populates sections (e.g., placeholders) of the transformed document 870 with textual content generated from the source document 850.

For example, the document transformation system 106 utilizes a language machine learning model to generate textual content to populate the target document 830. For example, the document transformation system 106 generates the textual content using direct generation based on the text transformation prompt to replace sections within the target document with textual content for a title 872, subtitle 886, subheading 874, subheading 876, section title 878, section title 882, bodytext 880, and bodytext 884 (corresponding to the title 832, the subtitle 834, the subheading 836, the subheading 838, the section title 840, the section title 842, the bodytext 844, and the bodytext 846).

In one or more embodiments, the document transformation system 106 utilizes a language machine learning model to populate the target document using iterative-based generation based on the text transformation prompt. For example, the document transformation system 106 the transformed document 870 starting at the higher level sections and iteratively filling in lower level sections. To illustrate, turning to FIG. 8C, the document transformation system 106 generates the textual content to fill sections within the target document to generate textual content for the title 872 in the first iteration, the subtitle 886 in the second iteration, the subheading 874 and the subheading 876 in the third iteration, the section title 878 and the section title 882 in the fourth iteration, and the bodytext 880 and the bodytext 884 in the fifth iteration. Notably, the document transformation system 106 generates textual content within the same level of the document hierarchy during the same iteration (e.g., the subheading 874 and the subheading 876 during the same iteration).

For example, the document transformation system 106 populates the target document 830 with source text generated from the source document 850. For example, the document transformation system 106 prompts the language machine learning model to generate textual content from the source document 850 to populate sections (e.g., placeholders) within the target document 830 based on the document hierarchy of the target document 830 and the named entity classifications. To illustrate, the document transformation system 106 generates textual content for title 852 (e.g., “John Doe”), subtitle 854 (e.g., “222-222-2222”), subtitle 856 (e.g., “Johnnydoe@email.com”), subheading 858 (e.g., “Interests”), and subheading 860 (e.g., “Jobs”). As shown in FIGS. 8A-8C, the document transformation system 106 populates the target document 830 to generate the transformed document 870.

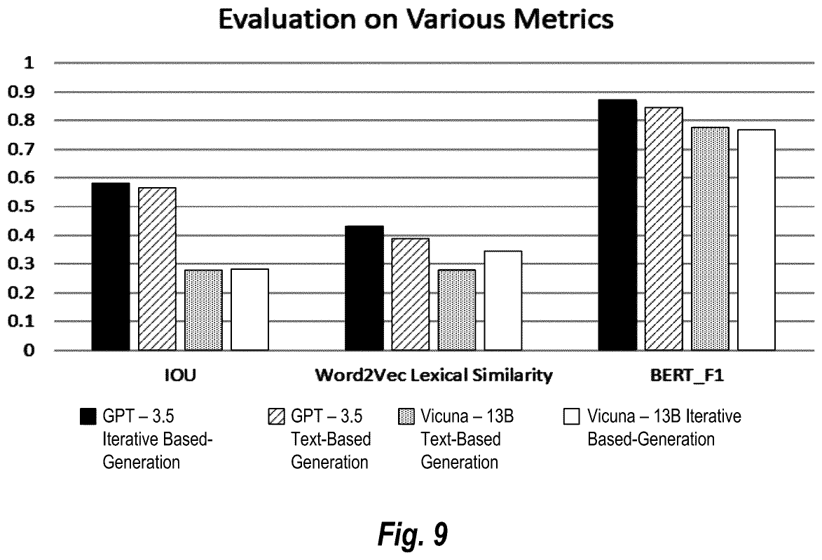

As mentioned, the document transformation system 106 accurately generates transformed documents that incorporate textual content from source documents while maintaining a semantic similarity with the source document and the style of the target document. FIG. 9 illustrates the results of an evaluation of the document transformation system 106 using various configurations in accordance with one or more embodiments.

As shown in FIG. 9, the document transformation system 106 provides accurate results when generating a text transformation prompt for use by a language machine learning model to generate a transformed document. In particular, FIG. 9 illustrates the accuracy of a comparison of a ground truth transformed document with a transformed document generated by the document transformation system 106. As shown, the document transformation system 106 is evaluated based on the GPT-3.5 large language model as disclosed by OpenAIGPT-3.5 API [gpt-3.5-turbo](2024). https.//platform.openai.com/docs/models/gpt-3-5-turbo. In addition, the document transformation system 106 is evaluated based on the Vicuna-13B large language model as disclosed by Chiang, et. al. Vicuna: An Open-Source Chatbot Impressing GPT-4 with 90% ChatGPT Quality (2023, March). As shown in FIG. 9, the results for the document transformation system 106 using both iterative-based generation (as described in FIG. 6) and utilizing text-based generation (direct generation given a text transformation prompt) closely align with a ground truth document.

To elaborate, the graph of FIG. 9 displays an Intersection over Union (IOU) evaluation that measures an overlap between the textual elements in the ground truth document and the transformed document generated by the document transformation system 106. As shown, these demonstrate the values closely align for the length and placement of the textual content between the ground truth document and the transformed document generated by the document transformation system 106.

As also shown, the graph of FIG. 9 displays a Word2Vec Lexical Similarity based on a pre-trained Word2Vec model showing the cosine similarity between the ground truth document and the transformed document generated by the document transformation system 106. As shown, these values demonstrate a close semantic similarity based on word embeddings.

In addition, the graph of FIG. 9 displays a Bert_F1 similarity between the ground truth document and the transformed document generated by the document transformation system 106 using BERT embeddings. As shown, these values demonstrate a cosine similarity between the tokens' embeddings measured by a similarity in context for the textual content.

As illustrated by FIG. 9, the high and consistent scores for the document transformation system 106 across the IOU, Word2Vec Lexical Similarity, and BERT_F1 metrics demonstrate that the document transformation system 106 is highly effective in generating accurate, semantically rich, and contextually appropriate text for the transformed documents. The document transformation system 106, using both iterative-based generation and text-based generation for the GPT-3.5 and the Vicuna-13B large language models, produces high-quality outputs when generating transformed documents.

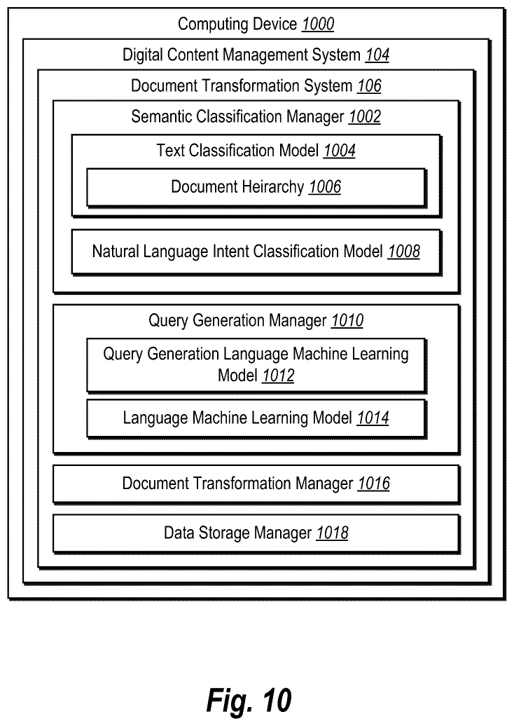

Turning now to FIG. 10, additional detail will now be provided regarding various components and capabilities of the document transformation system 106. In particular, FIG. 10 illustrates the document transformation system 106 implemented by the client device 1000 (e.g., the server device(s) 102 and/or one of the client device(s) 110 discussed above with reference to FIG. 1). Additionally, the document transformation system 106 is also part of the digital content management system 104. As shown in FIG. 10, the document transformation system 106 includes, but is not limited to, a semantic classification manager 1002, a query generation manager 1010, a document transformation manager 1016, and a data storage manager 1018.

As just mentioned, and as illustrated in FIG. 10, the document transformation system 106 includes the semantic classification manager 1002. In one or more embodiments, the semantic classification manager 1002 manages the classification of textual elements of a target document into a document hierarchy 1006 comprising semantically coherent sections. The semantic classification manager 1002 utilizes a text classification model 1004 to generate the document hierarchy 1006 by determining spatial coordinates and associated text classes for the textual elements of the target document. The semantic classification manager 1002 utilizes a natural language intent classification model 1008 to identify and classify named entities within the target document.

Additionally, as shown in FIG. 10, the document transformation system 106 includes the query generation manager 1010. The query generation manager 1010 manages the generation of queries for input to a language machine learning model to generate a transformed document. In particular, the query generation manager 1010 utilizes query generation language machine learning model 1012 to iteratively refine a target text prompt and generate a text transformation prompt for a language machine learning model 1014. In some embodiments, the query generation manager 1010 iteratively improves the text transformation prompt utilizing Beysian methods. In one or more embodiments, the query generation manager 1010 generates a text transformation prompt which is used by the document transformation manager 1016 to populate placeholders within the target document based on the document hierarchy and named entity classifications.

As further shown in FIG. 10, the document transformation system 106 includes the document transformation manager 1016. In particular, the document transformation system 106 utilizes the document transformation manager 1016 to generate a transformed documents based on the text transformation prompt. In some embodiments, the semantic classification manager manages the transformation of textual elements utilizing placeholders for textual elements within the target document and/or placeholders for content within the text transformation prompt. In particular, the document transformation manager 1016 utilizes the text transformation prompt as an input to the language machine learning model 1014 to generate the transformed documents from a source document and a target document. In certain embodiments, document transformation manager 1016 generates a transformed document by incorporating textual content from the source document into a target document while maintaining the style and aesthetics of the target document (e.g., text style of the target document).

Additionally, as shown, the document transformation system 106 includes a data storage manager 1018. In particular, data storage manager 1018 (implemented by one or more memory devices) stores the digital design documents, including the source documents, the target documents, and the transformed documents. The data storage manager 1018 facilitates the use of the digital documents by the document transformation system 106.

Each of the components 1002-1018 of the document transformation system 106 includes software, hardware, or both. For example, the components 1002-1018 include one or more instructions stored on a computer-readable storage medium and executable by processors of one or more computing devices, such as a client device or server device. When executed by the one or more processors, the computer-executable instructions of the document transformation system 106 causes the computing device(s) to perform the methods described herein. Alternatively, the components 1002-1018 include hardware, such as a special-purpose processing device to perform a certain function or group of functions. Alternatively, the components 1002-1018 of the document transformation system 106 include a combination of computer-executable instructions and hardware.

Furthermore, the components 1002-1018 of the document transformation system 106 are implemented as one or more operating systems, as one or more stand-alone applications, as one or more modules of an application, as one or more plug-ins, as one or more library functions or functions called by other applications, and/or as a cloud-computing model. Thus, in some embodiments, the components 1002-1018 of the document transformation system 106 are implemented as a stand-alone application, such as a desktop or mobile application. Furthermore, in some embodiments, the components 1002-1018 of the document transformation system 106 are implemented as one or more web-based applications hosted on a remote server. Alternatively, or additionally, the components 1002-1018 of the document transformation system 106 are implemented in a suite of mobile device applications or “apps.” For example, in one or more embodiments, the document transformation system 106 comprises or operates in connection with digital software applications such as: ADOBE® EXPRESS, ADOBE® ACROBAT, ADOBE® EXTRACT, and ADOBE® CREATIVE CLOUD®. The foregoing are either registered trademarks or trademarks of Adobe Inc. in the United States and/or other countries.

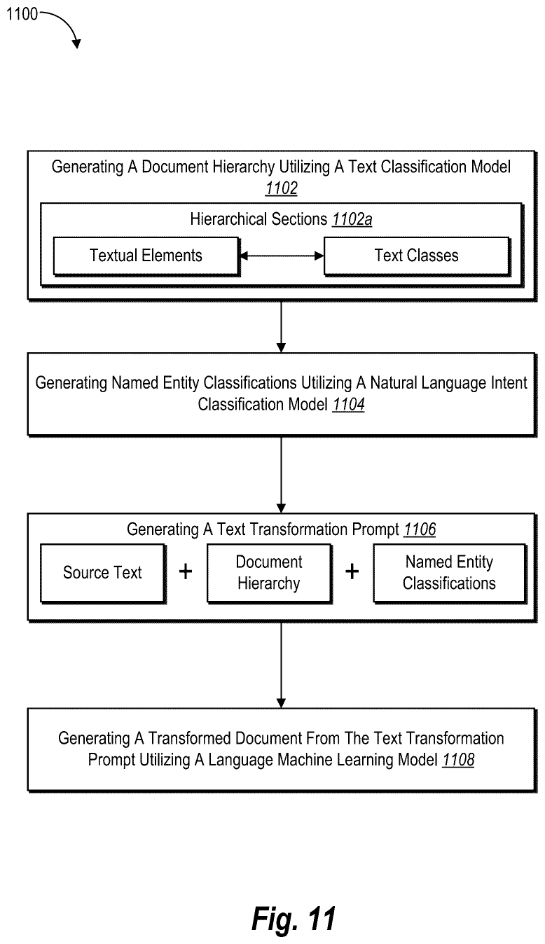

FIGS. 1-10, the corresponding text, and the examples provide a number of different methods, systems, devices, and non-transitory computer-readable media of the document transformation system 106. In addition to the foregoing, one or more embodiments are also described in terms of flowcharts comprising acts for accomplishing a particular result, as shown in FIG. 11. In some embodiments, the acts shown in FIG. 11 are performed in connection with more or fewer acts. Further, the acts may be performed in differing orders. Additionally, in various embodiments, the acts described herein are repeated or performed in parallel with one another or parallel with different instances of the same or similar acts. A non-transitory computer-readable medium includes instructions that, when executed by one or more processors, cause a computing device to perform the acts of FIG. 11. In some embodiments, a system is configured to perform the acts of FIG. 11. Alternatively, the acts of FIG. 11 are performed as part of a computer-implemented method.

FIG. 11 illustrates a flowchart of a series of acts 1100 for modifying a digital document with a document transformation system 106 in accordance with one or more embodiments. While FIG. 11 illustrates acts according to one embodiment, alternative embodiments omit, add to, reorder, and/or modify any acts shown in FIG. 11.

FIG. 11 illustrates an example series of acts 1100 for utilizing a document transformation system 106 to generate a transformed document based on source text, a document hierarchy, and named entity classifications. In particular, in certain embodiments, the series of acts 1100 includes an act 1102 of generating a document hierarchy utilizing a text classification model, and a sub-act 1102a of organizing the document hierarchy into hierarchical sections comprising textual elements and corresponding text classes. Specifically, in one or more embodiments, the act 1102 includes generating, utilizing a text classification model, a document hierarchy comprising textual elements and corresponding text classes from the target document organized into hierarchical sections.

Furthermore, in certain embodiments, the series of acts 1100 includes an act 1104 of generating named entity classifications using a natural language intent classification model. In particular, in one or more embodiments, the act 1104 includes generating, utilizing a natural language intent classification model, named entity classifications for a plurality of the textual elements from the target document. As illustrated, in some embodiments, the series of acts 1100 also includes an act 1106 of generating a text transformation prompt based on source text, a document hierarchy, and named entity classifications. In particular, in one or more embodiments, the act 1106 includes combining the source text, the document hierarchy, and the named entity classifications to generate a text transformation prompt. Furthermore, in certain embodiments, the series of acts 1100 includes an act 1108 of generating a transformed document from the text transformation prompt utilizing a language machine learning model. Specifically, in one or more embodiments, the act 1108 includes generating, utilizing a language machine learning model, a transformed document from the text transformation prompt.

In addition (or in the alternative) to the acts described above, in certain embodiments, the document transformation system series of acts 1100 includes generating an initial text transformation prompt. In some embodiments, the series of acts 1100 also includes generating, utilizing an additional language machine learning model, the text transformation prompt by refining the initial text transformation prompt based on a training source document and a training target document. Moreover, in one or more embodiments, the document transformation system 106 series of acts 1100 includes iteratively refining the initial text transformation prompt utilizing Bayesian optimization.

Furthermore, in one or more embodiments, the document transformation system series of acts 1100 includes a source document comprising a long-form document and includes mapping, utilizing the language machine learning model, summarized text from the source text of the source document to textual elements of the target document to generate the transformed document. Moreover, in one or more embodiments, the series of acts 1100 includes sorting the textual elements into the hierarchical sections based on the text classes and spatial coordinates of the textual elements within the target document. Further still, in one or more embodiments, the series of acts 1100 includes generating, utilizing the language machine learning model, the transformed document by sorting the textual elements into the hierarchical sections by iteratively traversing the document hierarchy to populate a first hierarchical section and a second hierarchical section.

Moreover, in one or more embodiments, the series of acts 1100 includes identifying placeholder fields placeholder fields corresponding to areas within the target document. In certain embodiments, the series of acts 1100 further includes generating the text transformation prompt comprising instructions to replace the textual elements within the placeholder fields of the target document based on the source text, the document hierarchy, and the named entity classifications. Moreover, one or more embodiments, the series of acts 1100 includes determining a target word count corresponding to a word count of a textual element within the target document. Furthermore, in one or more embodiments, the series of acts 1100 includes generating, utilizing the language machine learning model, the transformed document by replacing the textual element with transformed source text from the source document based on the target word count.

Moreover, in one or more embodiments, the series of acts 1100 includes generating, utilizing a natural language intent classification model, named entity classifications for the textual elements of the target document. In one or more embodiments, the series of acts 1100 includes building a document hierarchy for the target document by generating, utilizing a text classification model, text classes for the textual elements, organizing the textual elements into hierarchical sections according to the text classes, and sorting the textual elements within the hierarchical sections based on the text classes and spatial coordinates of the textual elements within the target document. Further still, in one or more embodiments, the series of acts 1100 includes transforming the source text to the target document by generating, utilizing a language machine learning model, a transformed document from the source text, the named entity classifications, and the document hierarchy.

Moreover, in one or more embodiments, the series of acts 1100 includes generating an initial text transformation prompt. In one or more embodiments, the series of acts 1100 further includes generating, utilizing an additional language machine learning model, a text transformation prompt by iteratively refining the initial text transformation prompt utilizing Bayesian optimization. In addition, in one or more embodiments, the series of acts 1100 includes generating, utilizing the language machine learning model, the transformed document by populating the hierarchical sections with transformed source text from the source document based on target word counts. Furthermore, in one or more embodiments, the series of acts 1100 includes generating the transformed document from a text transformation prompt generated by combining the source text, the document hierarchy, and the named entity classifications.

In addition, in one or more embodiments, the series of acts 1100 includes generating, utilizing the language machine learning model, summarized text from the source text of the source document. Moreover, in one or more embodiments, the series of acts 1100 includes mapping, utilizing the language machine learning model, the summarized text to textual elements within the target document to generate the transformed document. In one or more embodiments, the series of acts 1100 includes generating, utilizing the language machine learning model, an initial transformed document by populating a first section of the hierarchical sections of the target document based on the source text, the named entity classifications, and the document hierarchy. Furthermore, in one or more embodiments, the series of acts 1100 includes generating, utilizing the language machine learning model, the transformed document by populating a second section of the hierarchical sections of the target document based on the initial transformed document, the source text, the named entity classifications, and the document hierarchy.

In some embodiments, the series of acts 1100 also includes generating a document hierarchy of textual elements of a target document organized into hierarchical sections. Moreover, in one or more embodiments, the document transformation system 106 series of acts 1100 includes generating named entity classifications for the textual elements within the target document. Further still, in some embodiments, the document transformation system 106 series of acts 1100 includes generating, utilizing a language machine learning model, an initial transformed document by populating a first section of the hierarchical sections of the target document based on source text of a source document, the document hierarchy, and the named entity classifications. Furthermore, in one or more embodiments, the document transformation system series of acts 1100 includes generating, utilizing the language machine learning model, a transformed document by populating a second section of the hierarchical sections of the target document based on the initial transformed document, the source text, the document hierarchy, and the named entity classifications.

Moreover, one or more embodiments, the series of acts 1100 includes organizing the textual elements within the hierarchical sections of the document hierarchy by evaluating the textual elements based on spatial coordinates of the textual elements within the target document. Further still, in one or more embodiments, the series of acts 1100 includes generating, utilizing a text classification model, text classes for the textual elements. Moreover, in one or more embodiments, the series of acts 1100 includes organizing the textual elements into the hierarchical sections according to the text classes. In certain embodiments, the series of acts 1100 further includes determining a target word count corresponding to a word count of a textual element within the target document. Moreover, one or more embodiments, the series of acts 1100 includes generating, utilizing the language machine learning model, the transformed document by populating the first section of the hierarchical sections with transformed source text from the source document based on the target word count.

Furthermore, in one or more embodiments, the series of acts 1100 includes identifying placeholder fields within the target document comprising areas within the target document encompassing one or more of the textual elements. Moreover, in one or more embodiments, the series of acts 1100 includes generating a text transformation prompt comprising instructions to populate the placeholder fields of the target document utilizing the source text, the document hierarchy, and the named entity classifications. In one or more embodiments, the series of acts 1100 includes generating the transformed document utilizing the text transformation prompt. Further still, in one or more embodiments, the series of acts 1100 includes generating the transformed document by sorting the textual elements into the hierarchical sections by iteratively analyzing the document hierarchy to populate the first section of the hierarchical sections, the second section of the hierarchical sections, and a third section of the hierarchical sections.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 12 illustrates a block diagram of an example computing device 1200 that may be configured to perform one or more of the processes described above. One will appreciate that one or more computing devices, such as the computing device 1200 may represent the computing devices described above (e.g., server device(s) 102, client device(s) 110, and computing device 1200). In one or more embodiments, the computing device 1200 may be a mobile device (e.g., a mobile telephone, a smartphone, a PDA, a tablet, a laptop, a camera, a tracker, a watch, a wearable device, etc.). In some embodiments, the computing device 1200 may be a non-mobile device (e.g., a desktop computer or another type of client device). Further, the computing device 1200 may be a server device that includes cloud-based processing and storage capabilities.

As shown in FIG. 12, the computing device 1200 can include one or more processor(s) 1202, memory 1204, a storage device 1206, input/output interfaces 1208 (or “I/O interfaces 1208”), and a communication interface 1210, which may be communicatively coupled by way of a communication infrastructure (e.g., bus 1212). While the computing device 1200 is shown in FIG. 12, the components illustrated in FIG. 12 are not intended to be limiting. Additional or alternative components may be used in other embodiments. Furthermore, in certain embodiments, the computing device 1200 includes fewer components than those shown in FIG. 12. Components of the computing device 1200 shown in FIG. 12 will now be described in additional detail.

In particular embodiments, the processor(s) 1202 includes hardware for executing instructions, such as those making up a computer program. As an example, and not by way of limitation, to execute instructions, the processor(s) 1202 may retrieve (or fetch) the instructions from an internal register, an internal cache, memory 1204, or a storage device 1206 and decode and execute them.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1204 may be internal or distributed memory.

The computing device 1200 includes a storage device 1206 includes storage for storing data or instructions. As an example, and not by way of limitation, the storage device 1206 can include a non-transitory storage medium described above. The storage device 1206 may include a hard disk drive (HDD), flash memory, a Universal Serial Bus (USB) drive or a combination these or other storage devices.

As shown, the computing device 1200 includes one or more I/O interfaces 1208, which are provided to allow a user to provide input to (such as user strokes), receive output from, and otherwise transfer data to and from the computing device 1200. These I/O interfaces 1208 may include a mouse, keypad or a keyboard, a touch screen, camera, optical scanner, network interface, modem, other known I/O devices or a combination of such I/O interfaces 1208. The touch screen may be activated with a stylus or a finger.

The I/O interfaces 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1208 are configured to provide graphical data to a display for presentation to a user. The graphical data may be representative of one or more graphical user interfaces and/or any other graphical content as may serve a particular embodiment.

The computing device 1200 can further include a communication interface 1210. The communication interface 1210 can include hardware, software, or both. The communication interface 1210 provides one or more interfaces for communication (such as, for example, packet-based communication) between the computing device and one or more other computing devices or one or more networks. As an example, and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can include hardware, software, or both that connects components of computing device 1200 to each other.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method for transforming source text of a source document to a target document, the computer-implemented method comprising:
generating, utilizing a text classification model, a document hierarchy comprising textual elements and corresponding text classes from the target document organized into hierarchical sections;
generating, utilizing a natural language intent classification model, named entity classifications for a plurality of the textual elements from the target document;
combining the source text, the document hierarchy, and the named entity classifications to generate a text transformation prompt; and
generating, utilizing a language machine learning model, a transformed document from the text transformation prompt.

2. The computer-implemented method of claim 1, further comprising:
generating an initial text transformation prompt; and
generating, utilizing an additional language machine learning model, the text transformation prompt by refining the initial text transformation prompt based on a training source document and a training target document.

3. The computer-implemented method of claim 2, further comprising iteratively refining the initial text transformation prompt utilizing Bayesian optimization.

4. The computer-implemented method of claim 1, wherein the source document comprises a long-form document and further comprising mapping, utilizing the language machine learning model, summarized text from the source text of the source document to textual elements of the target document to generate the transformed document.

5. The computer-implemented method of claim 1, wherein generating the document hierarchy comprises sorting the textual elements into the hierarchical sections based on the text classes and spatial coordinates of the textual elements within the target document.

6. The computer-implemented method of claim 5, further comprising generating, utilizing the language machine learning model, the transformed document by sorting the textual elements into the hierarchical sections by iteratively traversing the document hierarchy to populate a first hierarchical section and a second hierarchical section.

7. The computer-implemented method of claim 1, further comprising generating the text transformation prompt by:
identifying placeholder fields corresponding to areas within the target document; and
generating the text transformation prompt comprising instructions to replace the textual elements within the placeholder fields of the target document based on the source text, the document hierarchy, and the named entity classifications.

8. The computer-implemented method of claim 1, further comprising:
determining a target word count corresponding to a word count of a textual element within the target document; and
generating, utilizing the language machine learning model, the transformed document by replacing the textual element with transformed source text from the source document based on the target word count.

9. A system comprising:
one or more memory devices comprising a source document having source text and a target document having textual elements; and
one or more processors coupled to the one or more memory devices, the one or more processors configured to cause the system to:
generate, utilizing a natural language intent classification model, named entity classifications for the textual elements of the target document;
build a document hierarchy for the target document by:
generating, utilizing a text classification model, text classes for the textual elements;
organizing the textual elements into hierarchical sections according to the text classes; and
sorting the textual elements within the hierarchical sections based on the text classes and spatial coordinates of the textual elements within the target document; and
transform the source text to the target document by generating, utilizing a language machine learning model, a transformed document from the source text, the named entity classifications, and the document hierarchy.

10. The system of claim 9, wherein the one or more processors are further configured to cause the system to generate the transformed document from the source text by:
generating an initial text transformation prompt; and
generating, utilizing an additional language machine learning model, a text transformation prompt by iteratively refining the initial text transformation prompt utilizing Bayesian optimization.

11. The system of claim 9, wherein the one or more processors are further configured to cause the system to generate, utilizing the language machine learning model, the transformed document by populating the hierarchical sections with transformed source text from the source document based on target word counts.

12. The system of claim 9, wherein the one or more processors are further configured to cause the system to generate the transformed document from a text transformation prompt generated by combining the source text, the document hierarchy, and the named entity classifications.

13. The system of claim 9, wherein the source document comprises a long-form document and the one or more processors are further configured to cause the system to:
generate, utilizing the language machine learning model, summarized text from the source text of the source document; and
map, utilizing the language machine learning model, the summarized text to textual elements within the target document to generate the transformed document.

14. The system of claim 9, wherein the one or more processors are further configured to cause the system to generate the transformed document by:
generating, utilizing the language machine learning model, an initial transformed document by populating a first section of the hierarchical sections of the target document based on the source text, the named entity classifications, and the document hierarchy; and
generating, utilizing the language machine learning model, the transformed document by populating a second section of the hierarchical sections of the target document based on the initial transformed document, the source text, the named entity classifications, and the document hierarchy.

15. A non-transitory computer readable medium storing executable instructions which, when executed by a processing device, cause the processing device to perform operations comprising:
generating a document hierarchy of textual elements of a target document organized into hierarchical sections;
generating named entity classifications for the textual elements within the target document;
generating, utilizing a language machine learning model, an initial transformed document by populating a first section of the hierarchical sections of the target document based on source text of a source document, the document hierarchy, and the named entity classifications; and
generating, utilizing the language machine learning model, a transformed document by populating a second section of the hierarchical sections of the target document based on the initial transformed document, the source text, the document hierarchy, and the named entity classifications.

16. The non-transitory computer readable medium of claim 15, wherein the operations further comprise organizing the textual elements within the hierarchical sections of the document hierarchy by evaluating the textual elements based on spatial coordinates of the textual elements within the target document.

17. The non-transitory computer readable medium of claim 16, wherein the operations further comprise:
generating, utilizing a text classification model, text classes for the textual elements; and
organizing the textual elements into the hierarchical sections according to the text classes.

18. The non-transitory computer readable medium of claim 15, wherein the operations further comprise:
determining a target word count corresponding to a word count of a textual element within the target document; and
generating, utilizing the language machine learning model, the transformed document by populating the first section of the hierarchical sections with transformed source text from the source document based on the target word count.

19. The non-transitory computer readable medium of claim 15, wherein generating the transformed document further comprises:
identifying placeholder fields within the target document comprising areas within the target document encompassing one or more of the textual elements;
generating a text transformation prompt comprising instructions to populate the placeholder fields of the target document utilizing the source text, the document hierarchy, and the named entity classifications; and
generating the transformed document utilizing the text transformation prompt.

20. The non-transitory computer readable medium of claim 15, wherein generating the transformed document further comprises generating the transformed document by sorting the textual elements into the hierarchical sections by iteratively analyzing the document hierarchy to populate the first section of the hierarchical sections, the second section of the hierarchical sections, and a third section of the hierarchical sections.
